(19) United States
(12) Patent Application Publication
(10) Pub. No.: US 2012/0176047 A1
(43) Pub. Date: Jul. 12, 2012

(54) Lighting Apparatus and Light Emitting Diode Device Thereof

(75) Inventors: Shun-Chang Li, New Taipei City (TW); Tzu-Hao Chao, New Taipei City (TW); Ching-Yun Ma, New Taipei City (TW)

(73) Assignee: EVERLIGHT ELECTRONICS CO., LTD., New Taipei City (TW)

(21) Appl. No.: 13/347,630

(22) Filed: Jan. 10, 2012

(30) Foreign Application Priority Data
Jan. 12, 2011 (TW) 100101135

(51) Int. Cl. H05B 37/02

(52) U.S. Cl. 315/185 R; 315/306

(57) ABSTRACT

The present invention provides a light emitting diode (LED) device. The LED device include a driver, a first LED coupled in series with the driver, and an impedance-providing component coupled in parallel with the first LED and in series with the driver. The impedance-providing component provides a shunt impedance having a value that varies in positive proportion with a variation in an ambient temperature. The driver is respectively coupled in series with the first LED and the at least one impedance-providing component. The driver provides a drive current divided to flow through the first LED and the at least one impedance-providing component according to the shunt impedance and the internal impedance.

### CROSS-REFERENCE TO RELATED APPLICATION

This application claims the priority benefit of Taiwan Patent Application No. 100101135, filed on Jan. 12, 2011. The entirety of the above-mentioned patent application is hereby incorporated by reference and made a part of this specification.

### BACKGROUND

1. Technical Field

The present invention relates to a lighting apparatus and the structure of a light emitting diode (LED) device thereof and, more particularly, to an LED device with reduced attenuation in brightness (luminous decay, light decay, light attenuation, light decline or light degradation) and a technique that reduces attenuation in brightness in red LED caused by an increase in temperature.

2. Description of Related Art

With demand for environmental protection on the rise, the utilization of LEDs for illumination in people's daily life has become an inevitable trend. According to conventional technologies, blue and red LED chips are often used in lighting apparatuses that provide warm lighting and for which yellow and red phosphors are used during the manufacturing thereof. As the time in operation of this type of lighting apparatuses increases, the ambient temperature surrounding the lighting apparatus typically rises accordingly. In particular, as red LEDs typically have more pronounced attenuation in brightness compared to blue LEDs, the attenuation in brightness (luminous decay, light decay, light attenuation, light decline or light degradation) is generally more severe in red LEDs than in blue LEDs. As such, the lighting provided by conventional lighting apparatuses tends to change drastically over time and the lighting performance of such lighting apparatuses is severely impaired.

Therefore, it is important for designers in this field to provide lighting apparatuses that are capable of long and stable operation with high efficiency in lighting.

### SUMMARY

The present invention provides an LED device that is capable of effectively reducing the attenuation in brightness in a string of red LEDs thereof caused by an increase in temperature.

The present invention further provides a lighting apparatus that is capable of effectively reducing the attenuation in brightness in a string of red LEDs thereof caused by an increase in temperature. Advantageously, the lighting apparatus can emit light under high ambient temperature such that the emitted light still satisfies the requirement of the 7-step macadam and, optimally, the requirement of the 4-step macadam.

In one aspect, an LED device may comprise a first LED, at least one impedance-providing component, and a driver. The first LED may have an internal impedance and may be configured to emit light of a first wavelength. The at least one impedance-providing component may be coupled in parallel with the first LED, and may provide a shunt impedance having a value that varies in positive proportion with a variation in an ambient temperature. The driver may be respectively coupled in series with the first LED and the at least one impedance-providing component. The driver may provide a drive current divided to flow through the first LED and the at least one impedance-providing component according to the shunt impedance and the internal impedance.

In one embodiment, the drive current is divided into a first partial drive current that flows through the first LED and a second partial drive current that flows through the at least one impedance-providing component. A ratio between a value of the first partial drive current and a value of the second partial drive current may be proportional to a ratio between a value of the shunt impedance provided by the at least one impedance-providing component and a value of the internal impedance of the first LED.

In one embodiment, the at least one impedance-providing component may comprise a plurality of impedance-providing components each of which providing a respective shunt impedance having a respective value that varies in positive proportion with the variation in the ambient temperature.

In one embodiment, the at least one impedance-providing component may comprise a semiconductor component, a thermistor, a transistor, or a diode having a positive temperature coefficient.

In one embodiment, the LED device may further comprise a second LED that is respectively coupled in series with the driver, the first LED, and the at least one impedance-providing component. The second LED may be configured to emit light of a second wavelength.

In one embodiment, the second LED, the first LED, and the driver may be coupled in series such that the second LED is coupled between the driver and the first LED or the first LED is coupled between the driver and the second LED.

In one embodiment, the second LED may comprise a blue LED, a green LED, a yellow LED, an orange LED, an ultraviolet LED, a near blue LED, a white LED, or a combination thereof.

In another aspect, an LED device may comprise a first LED, at least one impedance-providing component, a string of one or more second LEDs, and a driver. The first LED may have an internal impedance and may be configured to emit light of a first wavelength. The at least one impedance-providing component may be coupled in parallel with the first LED and provide a shunt impedance having a value that varies in positive proportion with a variation in an ambient temperature. The string of one or more second LEDs may be respectively coupled in series with the first LED and the at least one impedance-providing component. Each of the one or more second LEDs may be configured to emit light of a respective wavelength that is less than the first wavelength. The driver may be respectively coupled in series with the first LED, the string of one or more second LEDs, and the at least one impedance-providing component. The driver may provide a drive current to the string of one or more second LEDs. The drive current is divided to flow through the first LED and the at least one impedance-providing component according to the shunt impedance and the internal impedance.

In one embodiment, the drive current is divided into a first partial drive current that flows through the first LED and a second partial drive current that flows through the at least one impedance-providing component. A ratio between a value of the first partial drive current and a value of the second partial drive current may be proportional to a ratio between a value of the shunt impedance provided by the at least one impedance-providing component and a value of the internal impedance of the first LED.

In one embodiment, the at least one impedance-providing component may comprise a plurality of impedance-providing components each providing a respective shunt impedance having a respective value that varies in positive proportion with the variation in the ambient temperature.

In one embodiment, the at least one impedance-providing component may comprise a semiconductor component, a thermistor, a transistor, or a diode having a positive temperature coefficient.

In one embodiment, the first LED may comprise a red LED, and the string of one or more second LEDs may comprise a blue LED, a green LED, a yellow LED, an orange LED, an ultraviolet LED, a near blue LED, a white LED, or a combination thereof.

In one embodiment, the LED device may further comprise a string of one or more third LEDs that is respectively coupled in series with the driver, the first LED, the string of one or more second LEDs, and the at least one impedance-providing component. Each of the one or more third LEDs may be configured to emit light of a respective wavelength that is less than the first wavelength.

In one embodiment, the string of one or more third LEDs may be coupled in series and between the driver and the first LED.

In one embodiment, the first LED may comprise a red LED, and the string of one or more third LEDs may comprise a blue LED, a green LED, a yellow LED, an orange LED, an ultraviolet LED, a near blue LED, a white LED, or a combination thereof.

In one aspect, a lighting apparatus comprising a first LED, at least one impedance-providing component, a second LED and a driver is provided. The first LED has an internal impedance and a first light decay. The at least one impedance-providing component is coupled in parallel with the first LED. The at least one impedance-providing component provides a shunt impedance having a value that varies in positive proportion with a variation in an ambient temperature. The second LED is respectively coupled in series with the first LED and the at least one impedance-providing component. The second LED has a second decay. The first light decay is more severe than the second light decay. The driver is respectively coupled in series with the first LED, the second LED and the at least one impedance-providing component. The driver provides a drive current to the second LED. The drive current is divided to flow through the first LED and the at least one impedance-providing component according to the shunt impedance and the internal impedance.

In one embodiment, the at least one impedance-providing component comprises a semiconductor component, a thermistor, a transistor, or a diode having a positive temperature coefficient.

In one embodiment, a third LED is respectively coupled in series with the first LED, the second LED, the at least one impedance-providing component and the driver. The third LED has a third light decay.

In one embodiment, the first light decay is more severe than the third light decay.

In one embodiment, the third LED is coupled in series and between the driver and the first LED.

In one embodiment, the first LED comprises a red LED. The second LED comprises a blue LED, a green LED, a yellow LED, an orange LED, an ultraviolet LED, a near blue LED, a white LED, or a combination thereof. The third LED comprises a blue LED, a green LED, a yellow LED, an orange LED, an ultraviolet LED, a near blue LED, a white LED, or a combination thereof.

In one embodiment, the drive current is divided into a first partial drive current that flows through the first LED and a second partial drive current that flows through the at least one impedance-providing component. A ratio between a value of the first partial drive current and a value of the second partial drive current is proportional to a ratio between a value of the shunt impedance provided by the at least one impedance-providing component and a value of the internal impedance of the first LED.

In one aspect, a lighting apparatus may comprise an LED device. The LED device may include a first LED, at least one impedance-providing component, and a driver. The first LED may have an internal impedance and may be configured to emit light of a first wavelength. The at least one impedance-providing component may be coupled in parallel with the first LED and may provide a shunt impedance having a value that varies in positive proportion with a variation in an ambient temperature. The driver may be respectively coupled in series with the first LED, and the at least one impedance-providing component. The driver may provide a drive current that is divided into a first partial drive current that flows through the first LED and a second partial drive current that flows through the at least one impedance-providing component. A ratio between a value of the first partial drive current and a value of the second partial drive current may be proportional to a ratio between a value of the shunt impedance provided by the at least one impedance-providing component and a value of the internal impedance of the first LED.

In one embodiment, the at least one impedance-providing component may comprise a semiconductor component, a thermistor, a transistor, or a diode having a positive temperature coefficient.

In one embodiment, the lighting apparatus may further comprise a string of one or more second LEDs that is respectively coupled in series with the first LED and the driver. Each of the one or more second LEDs may be configured to emit light of a respective wavelength that is less than the first wavelength. In another embodiment, the lighting apparatus may additionally comprise a string of one or more third LEDs that is respectively coupled in series with the driver, the first LED, and the string of one or more second LEDs. Each of the one or more third LEDs may be configured to emit light of a respective wavelength that is less than the first wavelength.

In one embodiment, the string of one or more third LEDs may be coupled in series and between the driver and the first LED.

In one embodiment, the first LED may comprise a red LED. The string of one or more second LEDs may comprise a blue LED, a green LED, a yellow LED, an orange LED, an ultraviolet LED, a near blue LED, a white LED, or a combination thereof. The string of one or more third LEDs may comprise a blue LED, a green LED, a yellow LED, an orange LED, an ultraviolet LED, a near blue LED, a white LED, or a combination thereof.

In one embodiment, each of the at least one first LED may be coupled in parallel with a respective one of the at least one impedance-providing component. The lighting apparatus may further comprise a plurality of strings of one or more second LEDs. Each string of one or more second LEDs may be respectively coupled in series with a respective one of the at least one first LED and the driver. Each LED of each string of one or more second LEDs may be configured to emit light of a respective wavelength that is less than the first wavelength.

To facilitate better understanding of the features of and benefits provided by the present invention, implementation examples are provided in the Detailed Description section below with reference made to the accompanying drawings.

### BRIEF DESCRIPTION OF THE DRAWINGS

FIG. 1 is a block diagram of an LED device in accordance with an embodiment of the present invention.

FIG. 2A is a block diagram of an LED device in accordance with another embodiment of the present invention.

FIGS. 2B and 2C are diagrams showing a relationship between the lighting efficiency and relative brightness of an LED device and the ambient temperature.

FIG. 3A is a block diagram of an LED device in accordance with yet another embodiment of the present invention.

FIG. 3B is a block diagram of an LED device in accordance with still another embodiment of the present invention.

FIG. 4 is a block diagram of a lighting apparatus in accordance with an embodiment of the present invention.

### DETAILED DESCRIPTION OF PREFERRED EMBODIMENTS

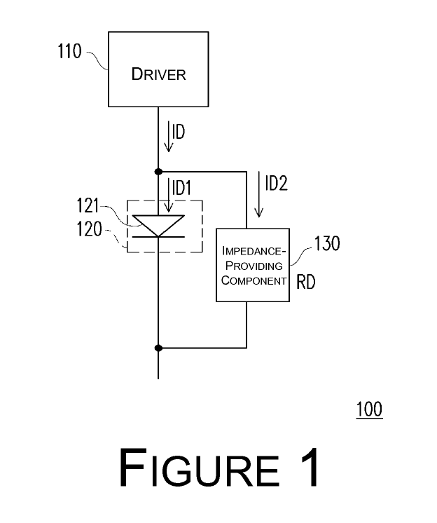

FIG. 1 illustrates an LED device 100 in accordance with an embodiment of the present invention. The LED device 100 includes a driver 110, a string of one or more red LEDs 120, and an impedance-providing component 130. The driver 110 provides a drive current ID. The driver 110 may include a current generator that utilizes a voltage-controlled current source or an independent current source to provide the drive current ID, which is stable. As current generating devices capable of providing a stable drive current are well known in the art, in the interest of brevity detailed description of the driver 110 will not be provided.

The string of one or more red LEDs 120 includes a quantity of N of LEDs 121 coupled in series, where N is a positive integer. FIG. 1 illustrates one exemplary implementation, and N is equal to 1 in FIG. 1. When the quantity of LEDs in the string of one or more red LEDs 120 is greater than 1, the N LEDs are coupled in the same direction (e.g., positively biased with respect to the driver 110) and in series.

The impedance-providing component 130 is coupled in parallel with the string of one or more red LEDs 120. The impedance-providing component 130 provides a shunt impedance RD the value of which depends on the ambient temperature surrounding the impedance-providing component 130. That is, according to Kirchhoff's current laws, the drive current ID provided by the driver 110 is divided into a first partial drive current ID1 and a second partial drive current ID2. The first partial drive current ID1 and the second partial drive current ID2 flow through the string of one or more red LEDs 120 and the impedance-providing component 130, respectively. The value of the drive current ID is equal to the sum of the value of the first partial drive current ID1 and the value of the second partial drive current ID2. More specifically, a voltage drop across the string of one or more red LEDs 120 is the same as a voltage drop across the impedance-providing component 130.

Moreover, a ratio between the value of the first partial drive current ID1 and the value of the second partial drive current ID2 is proportional to a ratio between a value of the shunt impedance RD provided by the impedance-providing component 130 and a value of an internal impedance of the string of one or more red LEDs 120. Notably, in at least one embodiment, the value of the shunt impedance RD provided by the impedance-providing component 130 varies in positive proportion with a variation in the ambient temperature. For example, when the ambient temperature increases, the shunt impedance RD increases proportionally.

In short, when the value of the shunt impedance RD provided by the impedance-providing component 130 is greater than the value of the internal impedance of the string of one or more red LEDs 120, the value of the first partial drive current ID1 is greater than the value of the second partial drive current ID2. Conversely, when the value of the shunt impedance RD provided by the impedance-providing component 130 is less than the value of the internal impedance of the string of one or more red LEDs 120, the value of the first partial drive current ID1 is less than the value of the second partial drive current ID2. When the value of the shunt impedance RD provided by the impedance-providing component 130 is equal to the value of the internal impedance of the string of one or more red LEDs 120, the drive current ID is equally divided between the first partial drive current ID1 and the second partial drive current ID2.

Based on the description above, it is clear that, when the LED device 100 is in operation for a long period of time, the value of the shunt impedance RD provided by the impedance-providing component 130 increases corresponding to an increase in the ambient temperature over time. As the value of the shunt impedance RD increases, the value of the first partial drive current ID1 that flows through the string of one or more red LEDs 120 also increases. The increase in the first partial drive current ID1 due to an increase in the ambient temperature effectively compensates for a decrease, or attenuation, in the brightness of the string of one or more red LEDs 120 that would result due to an increase in the ambient temperature had there been no such compensation.

Additionally, the value of the shunt impedance RD provided by the impedance-providing component 130 is selected based on the temperature-dependent attenuation in brightness of the string of one or more red LEDs 120 and a relationship between the brightness of the string of one or more red LEDs 120 and the drive current ID.

In at least one embodiment, the impedance-providing component 130 may comprise a thermistor with a positive temperature coefficient. When the LEDs 121 of the string of one or more red LEDs 120 comprise red LED chips, the impedance-providing component 130 may be a semiconductor component having a positive temperature coefficient, e.g., a transistor or a diode with a positive temperature coefficient, fabricated during the chip fabrication process.

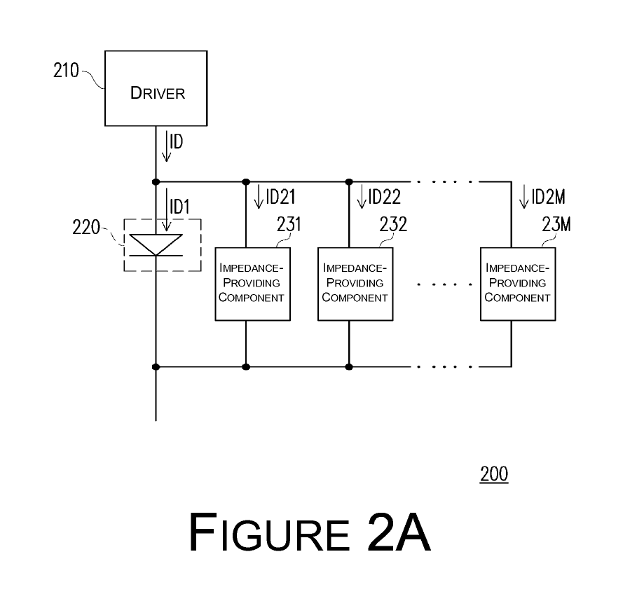

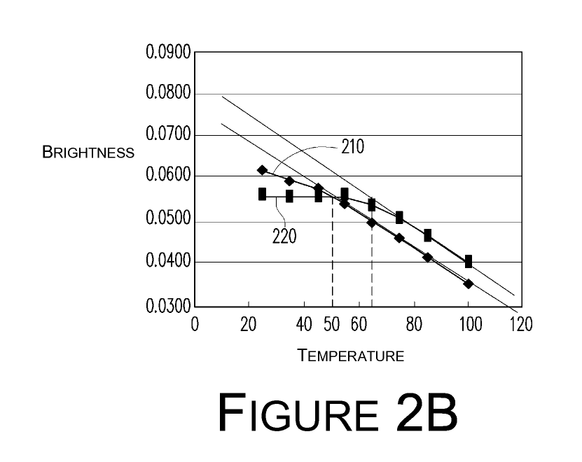

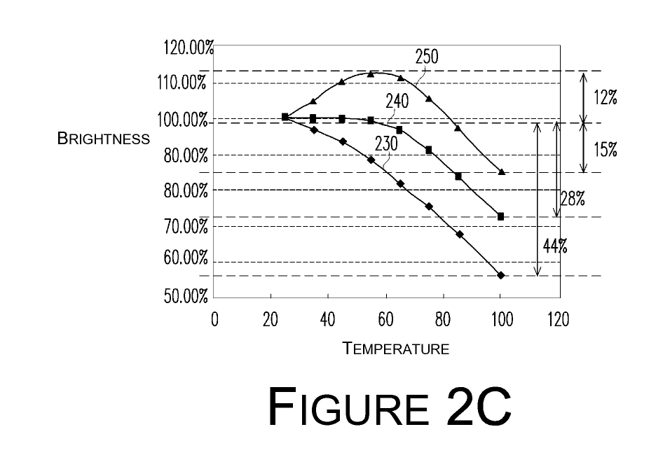

FIG. 2A illustrates an LED device 200 in accordance with another embodiment of the present invention. The LED device 200 includes a driver 210, a string of one or more red LEDs 220, and a plurality of impedance-providing components 231-23M. Compared with the previous example, the LED device 200 includes a quantity of M of impedance-providing components 231-23M, where M is a positive integer. Each of the impedance-providing components 231-23M is coupled in parallel with the string of one or more red LEDs 220. Moreover, the plurality of impedance-providing components 231-23M provide a plurality of shunt impedance each having a respective value that varies in positive proportion with a variation in the ambient temperature. In the illustrated example, the string of one or more red LEDs 220 includes three LEDs coupled in series. The driver 210 provides a drive current ID that is divided into a plurality of partial drive currents ID1, ID21-ID2M. The values of the partial drive currents ID1, ID21-ID2M depend on the values of the shunt impedance of the plurality of impedance-providing components 231-23M and a value of the internal impedance of the string of one or more red LEDs 220. More specifically, the partial drive current ID1 flows through the string of one or more red LEDs 220 to cause the string of one or more red LEDs 220 to emit light. Additionally, a voltage drop across the string of one or more red LEDs 220 is the same as a respective voltage drop across each of the plurality of the impedance-providing components 231-23M.

FIGS. 2B and 2C illustrate a relationship between the lighting efficiency and relative brightness of an LED device and the ambient temperature, respectively. As shown in FIG. 2B, a curve 210 shows a relationship between the lighting efficiency of a conventional LED device and the ambient temperature, where the conventional LED device includes a string of one or more red LEDs having two LEDs coupled in series without any impedance-providing component. A curve 220 shows a relationship between the lighting efficiency of a proposed LED device and the ambient temperature, where the proposed LED device includes a string of one or more red LEDs having two LEDs coupled in series and one or more impedance-providing components coupled in parallel with the string of one or more red LEDs. More specifically, the string of one or more red LEDs of the conventional LED device indicated by the curve 210 suffers a large attenuation in brightness when the ambient temperature is greater than 50° C. In contrast, the string of one or more red LEDs of the proposed LED device indicated by the curve 220 does not suffer a noticeable attenuation in brightness until the ambient temperature is greater than 60° C.

As shown in FIG. 2C, a curve 230 shows a relationship between the relative brightness of lighting of a conventional LED device and the ambient temperature, where the conventional LED device includes a string of one or more red LEDs having two LEDs coupled in series without any impedance-providing component. A curve 240 shows a relationship between the relative brightness of lighting of a proposed LED device and the ambient temperature, where the proposed LED device includes a string of two red LEDs coupled in series and two impedance-providing components that are coupled in parallel with each other and in parallel with the string of two red LEDs. A curve 250 shows a relationship between the relative brightness of lighting of another proposed LED device and the ambient temperature, where the proposed LED device includes a string of three red LEDs coupled in series and three impedance-providing components that are coupled in parallel with each other and in parallel with the string of three red LEDs. More specifically, when the ambient temperature is 100° C., the attenuation in brightness in the string of one or more red LEDs indicated by the curve 230 is 44%, the attenuation in brightness in the string of two red LEDs indicated by the curve 240 is 28%, and the attenuation in brightness in the string of three red LEDs indicated by the curve 250 is merely 12%.

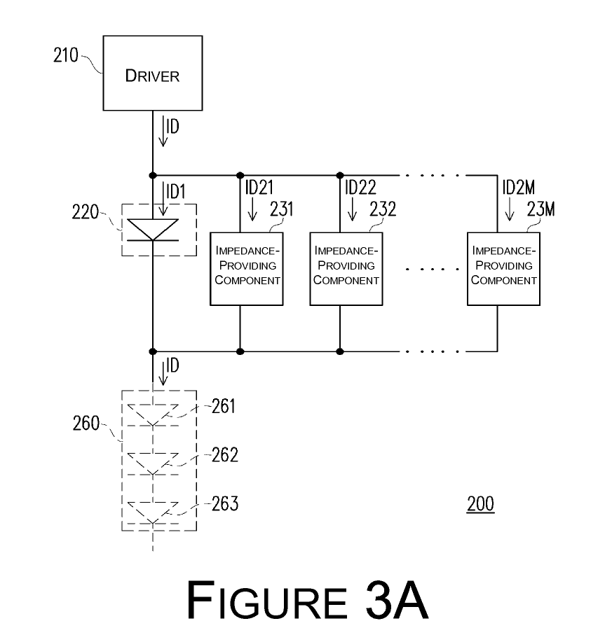

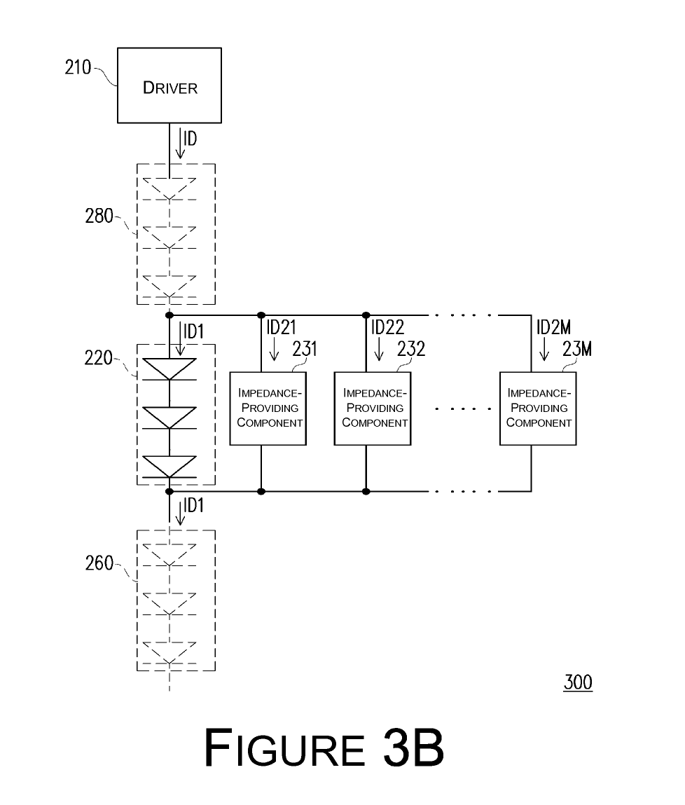

FIG. 3A illustrates an LED device 200 in accordance with yet another embodiment of the present invention. Compared with the example shown in FIG. 2A, the LED device 200 in FIG. 3A further includes an LED string 260. The LED string 260 and the string of one or more red LEDs 220 are coupled in series with the driver 210, and receive the drive current ID to emit light. The LED string 260 includes one or more non-red LEDs. In the example shown, the LED string 260 includes a plurality of non-red LEDs 261-263 that are coupled in series. A current input terminal of the LED 261 is coupled to a current output terminal of the string of one or more red LEDs 220. The current input terminal of the LED 261 is further coupled to a respective current output terminal of each of the plurality of impedance-providing components 231-23M. With the addition of the LED string 260, the color of the light emitted by the LED device 200 may be changed.

FIG. 3B illustrates an LED device 300 in accordance with still another embodiment of the present invention. Compared with the example shown in FIG. 3A, the LED device 300 includes two strings of non-red LEDs, namely a string of one or more non-red LEDs 260 and a string of one or more non-red LEDs 280. The string of one or more non-red LEDs 280 may be coupled in series between the driver 210 and the string of one or more red LEDs 220. In various embodiments, the strings of one or more non-red LEDs 260 and 280 may be placed in various locations in the circuit and still be coupled in series with the driver 210 and the string of one or more red LEDs 220. Furthermore, the quantity of strings of one or more non-red LEDs is not limited to the two strings 260 and 280.

Of course, the quantity of LEDs in each of the strings of one or more non-red LEDs 260 and 280 is not limited to 3. In various embodiments, the proposed technique may be implemented with each of the strings of one or more non-red LEDs 260 and 280 including at least one non-red LED. Additionally, the attenuation in brightness (luminous decay, light attenuation, light decay, light decline or light degradation) is generally more severe in red LEDs than in non-red LEDs.

In one embodiment, either or both of the strings of one or more non-red LEDs 260 and 280 may include one or more blue LEDs. In one embodiment, the strings of one or more non-red LEDs 260 and 280 may include one or more non-red LEDs of one or more other colors such as, for example, a blue LED, a green LED, a yellow LED, an orange LED, an ultraviolet LED, a near blue LED, a white LED, or a combination thereof.

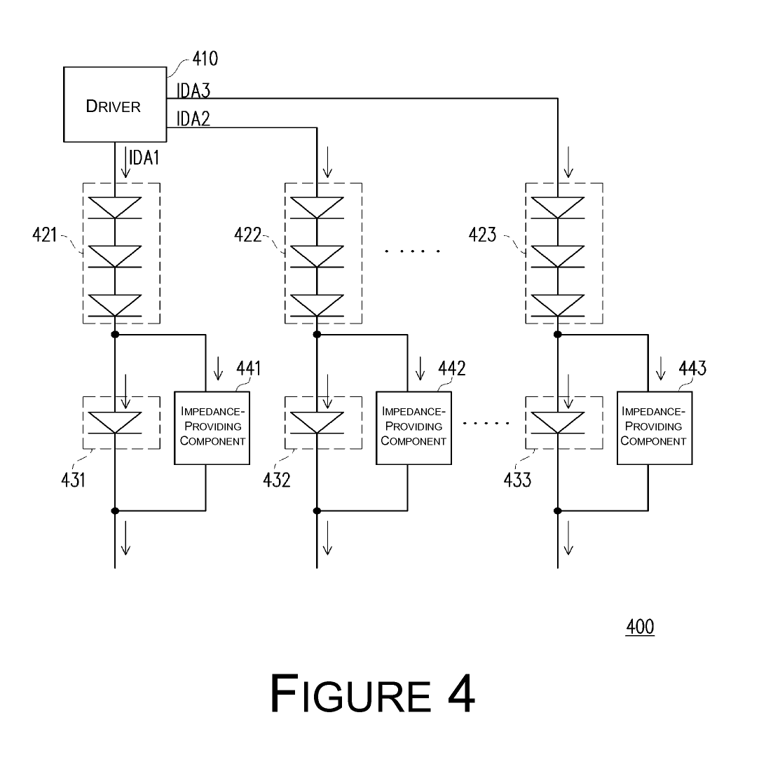

FIG. 4 illustrates a lighting apparatus 400 in accordance with an embodiment of the present invention. The lighting apparatus 400 includes a driver 410, a plurality of strings of one or more blue LEDs 421-423, a plurality of strings of one or more red LEDs 431-433, and a plurality of impedance-providing components 441-443. The driver 410 generates a plurality of drive currents IDA1-IDA3 that are provided to the strings of one or more blue LEDs 421-423, respectively. More specifically, after flowing through the string of one or more blue LEDs 421, the drive current IDA1 is divided to flow through the impedance-providing component 441 and the string of one or more red LEDs 431. After flowing through the string of one or more blue LEDs 422, the drive current IDA2 is divided to flow through the impedance-providing component 442 and the string of one or more red LEDs 432. After flowing through the string of one or more blue LEDs 423, the drive current IDA3 is divided to flow through the impedance-providing component 443 and the string of one or more red LEDs 433. The wavelength of the light emitted by each of the strings of one or more red LEDs 431-433 is greater than the wavelength of the light emitted by each of the strings of one or more blue LEDs 421-423. In general, each non-red LED in the present invention is selected such that the wavelength of the light emitted by a red LED is greater than the wavelength of the non-red LED.

The driver 410 may utilize a current mirror to mirror the drive current IDA1 to provide the drive currents IDA2 and IDA3. As circuits of current mirrors are well known in the art, in the interest of brevity a detailed description thereof will not be provided herein.

With respect to the compensation for the attenuation in the brightness of the strings of one or more red LEDs 431-433 using the impedance-providing components 441-443, since an example and the principle of operation have been provided above, in the interest of brevity a detailed description thereof will not be provided herein.

In summary, by coupling one or more impedance-providing components in parallel with a string of one or more red LEDs, the present invention provides a shunt impedance having a value that depends on the ambient temperature. Correspondingly, the value of a partial drive current of a drive current provided by the driver that flows through the string of one or more red LEDs varies in accordance with the variation in the value of the shunt impedance. Thus, the partial drive current that flows through the string of one or more red LEDs is adjusted according to the ambient temperature, thereby effectively compensating for the attenuation in brightness due to a rise in ambient temperature. This technique allows a lighting apparatus to emit light under high ambient temperature such that the emitted light still satisfies the requirement of the 7-step macadam and, optimally, the requirement of the 4-step macadam. In order to allow an impedance-providing component to effectively sense the ambient temperature to vary the partial drive current that flows through a string of one or more red LEDs, a distance between the impedance-providing component and the LEDs of the string of one or more red LEDs is no more than 5 centimeters. This distance is ideally less than 4 centimeters and optimally less than 3 centimeters. This design allows the impedance-providing component to effectively sense the ambient temperature so that the value of its shunt impedance varies proportionally according to a variation in the ambient temperature. In various embodiments, the LEDs described herein may be in the form of LED chips, LED packages, or a combination thereof.

A lighting apparatus in accordance with the present invention may be used in combination with any of the commercially available lighting modules, such as A40, A60, MR16, PAR30, PAR38 or GU10, with the use of yellow phosphor to produce white light. Moreover, red phosphor may be added to enhance color saturation. Furthermore, LED devices in accordance with the present invention may be used in indoor lighting apparatuses, outdoor lighting apparatuses, backlight modules, and indicator devices.

Although specific embodiments of the present invention have been disclosed, it will be understood by those of ordinary skill in the art that the foregoing and other variations in form and details may be made therein without departing from the spirit and the scope of the present invention. The scope of the present invention is defined by the claims provided herein.

What is claimed is:

1. A light emitting diode (LED) device, comprising:
a first LED having an internal impedance and configured to emit light of a first wavelength;
at least one impedance-providing component coupled in parallel with the first LED, the at least one impedance-providing component providing a shunt impedance having a value that varies in positive proportion with a variation in an ambient temperature; and
a driver respectively coupled in series with the first LED and the at least one impedance-providing component, the driver providing a drive current divided to flow through the first LED and the at least one impedance-providing component according to the shunt impedance and the internal impedance.

2. The LED device as recited in claim 1, wherein the at least one impedance-providing component comprises a plurality of impedance-providing components each of which providing a respective shunt impedance having a respective value that varies in positive proportion with the variation in the ambient temperature.

3. The LED device as recited in claim 1, wherein the at least one impedance-providing component comprises a semiconductor component, a thermistor, a transistor, or a diode having a positive temperature coefficient.

4. The LED device as recited in claim 1, further comprising:
a second LED that is respectively coupled in series with the driver, the first LED, and the at least one impedance-providing component, the second LED configured to emit light of a second wavelength.

5. The LED device as recited in claim 4, wherein the second LED, the first LED, and the driver are coupled in series such that the second LED is coupled between the driver and the first LED or the first LED is coupled between the driver and the second LED.

6. The LED device as recited in claim 1, wherein the drive current is divided into a first partial drive current that flows through the first LED and a second partial drive current that flows through the at least one impedance-providing component, a ratio between a value of the first partial drive current and a value of the second partial drive current is proportional to a ratio between a value of the shunt impedance provided by the at least one impedance-providing component and a value of the internal impedance of the first LED.

7. A light emitting diode (LED) device, comprising:
a first LED having an internal impedance and configured to emit light of a first wavelength;
at least one impedance-providing component coupled in parallel with the first LED, the at least one impedance-providing component providing a shunt impedance having a value that varies in positive proportion with a variation in an ambient temperature;
a string of one or more second LEDs respectively coupled in series with the first LED and the at least one impedance-providing component, each of the one or more second LEDs configured to emit light of a respective wavelength that is less than the first wavelength; and
a driver respectively coupled in series with the first LED, the string of one or more second LEDs, and the at least one impedance-providing component, the driver providing a drive current to the string of one or more second LEDs, the drive current is divided to flow through the first LED and the at least one impedance-providing component according to the shunt impedance and the internal impedance.

8. The LED device as recited in claim 7, wherein the at least one impedance-providing component comprises a plurality of impedance-providing components each of which providing a respective shunt impedance having a respective value that varies in positive proportion with the variation in the ambient temperature.

9. The LED device as recited in claim 7, wherein the at least one impedance-providing component comprises a semiconductor component, a thermistor, a transistor, or a diode having a positive temperature coefficient.

10. The LED device as recited in claim 7, wherein the first LED comprises a red LED, and wherein the string of one or more second LEDs comprises a blue LED, a green LED, a yellow LED, an orange LED, an ultraviolet LED, a near blue LED, a white LED, or a combination thereof.

11. The LED device as recited in claim 7, further comprising:
a string of one or more third LEDs that is respectively coupled in series with the driver, the first LED, the string of one or more second LEDs, and the at least one impedance-providing component, each of the one or more third LEDs configured to emit light of a respective wavelength that is less than the first wavelength.

12. The LED device as recited in claim 11, wherein the string of one or more third LEDs is coupled in series and between the driver and the first LED.

13. The LED device as recited in claim 11, wherein the drive current is divided into a first partial drive current that flows through the first LED and a second partial drive current that flows through the at least one impedance-providing component, a ratio between a value of the first partial drive current and a value of the second partial drive current is proportional to a ratio between a value of the shunt impedance provided by the at least one impedance-providing component and a value of the internal impedance of the first LED.

14. A lighting apparatus, comprising:
a first LED having an internal impedance and a first light decay; at least one impedance-providing component coupled in parallel with the first LED, the at least one impedance-providing component providing a shunt impedance having a value that varies in positive proportion with a variation in an ambient temperature;
a second LED respectively coupled in series with the first LED and the at least one impedance-providing component, the second LED having a second decay, the first light decay being more severe than the second light decay; and
a driver respectively coupled in series with the first LED, the second LED and the at least one impedance-providing component, the driver providing a drive current to the second LED, the drive current being divided to flow through the first LED and the at least one impedance-providing component according to the shunt impedance and the internal impedance.

15. The lighting apparatus as recited in claim 14, wherein the at least one impedance-providing component comprises a semiconductor component, a thermistor, a transistor, or a diode having a positive temperature coefficient.

16. The lighting apparatus as recited in claim 14, further comprising:
a third LED respectively coupled in series with the first LED, the second LED, the at least one impedance-providing component, and the driver, wherein the third LEDs has a third light decay.

17. The lighting apparatus as recited in claim 16, wherein the first light decay is more severe than the third light decay.

18. The lighting apparatus as recited in claim 17, wherein the third LED is coupled in series and between the driver and the first LED.

19. The lighting apparatus as recited in claim 17, wherein the first LED comprises a red LED, wherein the second LED comprises a blue LED, a green LED, a yellow LED, an orange LED, an ultraviolet LED, a near blue LED, a white LED, or a combination thereof, and wherein the third LED comprises a blue LED, a green LED, a yellow LED, an orange LED, an ultraviolet LED, a near blue LED, a white LED, or a combination thereof.

20. The lighting apparatus as recited in claim 14, wherein the drive current is divided into a first partial drive current that flows through the first LED and a second partial drive current that flows through the at least one impedance-providing component, a ratio between a value of the first partial drive current and a value of the second partial drive current is proportional to a ratio between a value of the shunt impedance provided by the at least one impedance-providing component and a value of the internal impedance of the first LED.
